(19) United States
(12) Patent Application Publication
(10) Pub. No.: US 2026/0310550 A1
(43) Pub. Date: Oct. 8, 2026

(54) HANDLING PARITY DATA DURING DATA FOLDING IN A MEMORY DEVICE

(71) Applicants: Donghua Zhou, Suzhou City (CN); Meng Wei, Shanghai (CN); Yue Wei, Shanghai (CN)

(72) Inventors: Donghua Zhou, Suzhou City (CN); Meng Wei, Shanghai (CN); Yue Wei, Shanghai (CN)

(21) Appl. No.: 18/996,830

(22) PCT Filed: Jul. 21, 2022
(86) PCT No.: PCT/CN2022/106999

§ 371 Date: Jan. 17, 2025

(51) Int. Cl. G06F 11/10; G06F 12/0882

(52) U.S. Cl. CPC G06F 11/1064; G06F 11/1048; G06F 12/0882

(57) ABSTRACT

Data from a first page identified for folding is read. The first page corresponds to a page stripe that includes at least a second page. Parity data associated with the page stripe is read from the second page. Updated parity data for the page stripe is generated based on the data read from the first page and the parity data read from the second page. The updated parity data is written to a first location in the memory device determined based on a write cursor. The data read from the first page is folded to a second location in the memory device determined based on the write cursor.

### TECHNICAL FIELD

Embodiments of the disclosure relate generally to memory sub-systems and more specifically to handling parity data during data folding.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing system that includes a memory sub-system, in accordance with some embodiments of the present disclosure.

FIGS. 2A and 2B are conceptual diagrams illustrating example interactions between components of a memory sub-system in performing data folding, in accordance with some embodiments of the present disclosure.

FIGS. 3 and 4 are flow diagrams illustrating an example method for performing data folding in a memory device, in accordance with some embodiments of the present disclosure.

FIG. 5 is a flow diagram illustrating an example method for retrieving parity data to be used in performing data recovery in a memory device, in accordance with some embodiments of the present disclosure.

FIG. 6 is a block diagram of an example computer system in which embodiments of the present disclosure may operate.

### DETAILED DESCRIPTION

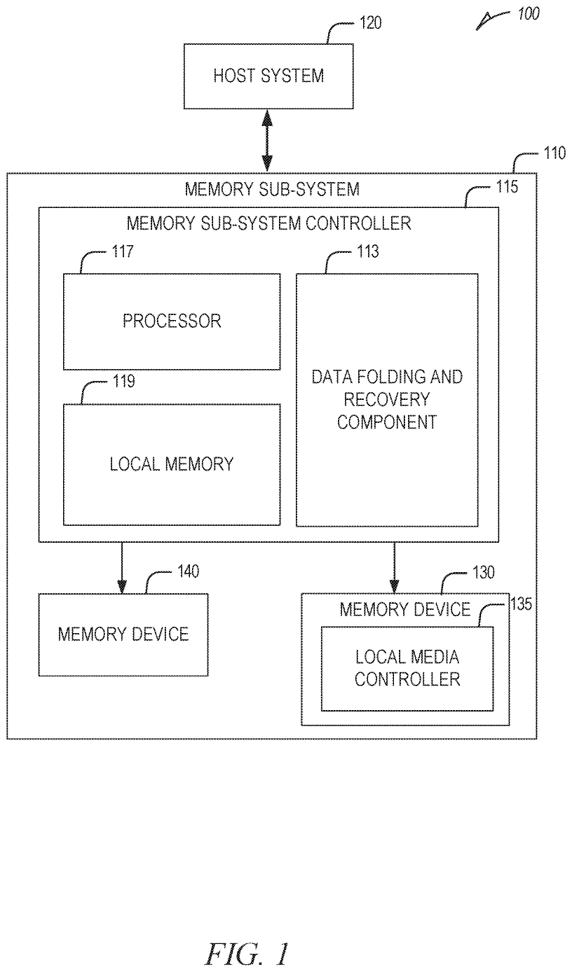

Aspects of the present disclosure are directed to an approach to folding data in a block of a memory device in a memory sub-system that includes storing parity data with fold data. A memory sub-system can be a storage device (e.g., solid-state drive (SSD)), a memory module, or a combination of a storage device and memory module. Examples of other storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory device can be a non-volatile memory device. One example of non-volatile memory devices is a negative- and (NAND) memory device. Other examples of non-volatile memory devices are described below in conjunction with FIG. 1. A NAND memory device can include multiple NAND dies. Each die may include one or more planes and each plane includes multiple blocks. Each block includes an array that includes pages (rows) and strings (columns). A string includes a plurality of memory cells connected in series. A memory cell (“cell”) is an electronic circuit that stores information. Depending on the cell type, a cell can store one or more bits of binary information and has various logic states that correlate to the number of bits being stored. The logic states can be represented by binary values, such as “0” and “1,” or combinations of such values.

Various memory access operations can be performed on the memory cells. Data can be written to, read from, and erased from memory cells. Memory cells can be grouped into a write unit, such as a page. For some types of memory devices, a page is the smallest write unit. A page size represents a particular number of cells of a page. For some types of memory devices (e.g., NAND), memory cells can be grouped into an erase unit, such as a block. Data can be written to a block, page-by-page. Data can be erased at a block level. However, portions of a block cannot be erased.

A protection scheme such as parity protection is typically used in memory devices to prevent wanted data loss. With parity protection, parity data that is used to recover stored data (e.g., user data and metadata) is stored by a memory sub-system and retrieved during data recovery. The manner in which parity data is generated, stored, and used in data recovery may vary by implementation. For some implementations (e.g., redundant array of independent NAND (RAIN)), parallel blocks within a memory device are organized into block stripes. Pages within each die may be identified by page number, and pages with the same page number are grouped to form a page stripe. Conventionally, in these implementations, parity data is generated for each page stripe (e.g., by applying a logical XOP operator to data stored by each page in the page stripe) and the parity data is typically stored in the last page of the page stripe (e.g., the page of the page stripe that is in the last die). As an example, for a memory device with n dies, parity data for a page stripe x (comprising each page x from each die in the memory device) can be computed as follows:

$${Die}_{n - 1} {Pg}_{x} = {Die}_{0} {Pg}_{x} ⊕ {Die}_{1} {Pg}_{x} ⊕ {Die}_{2} {Pg}_{x} ⊕ … ⊕ {Die}_{n - 3} {Pg}_{x} ⊕ {Die}_{n - 2} {Pg}_{x}$$

where Dieₙ₋₁Pgₓ refers to the parity data for the page stripe x stored by page x in the last die (Dieₙ₋₁).

A bad block (also referred to herein as “invalid block”) hereinafter refers to block that is no longer reliable for storing or retrieving data, for example, due to a defect (e.g., manufacturing defect) or due to wear, and may incorrectly store bit values. An incorrect bit value is hereinafter referred to as an invalid bit. A grown bad block (GBB) hereinafter refers to a block being unreliable due to wear or defect. A grown bad block can be identified based on a threshold (e.g., bit error rates (BER) threshold).

In certain instances, such as when a failure of a block is detected or when a block is identified as a bad block, folding may be performed on a block. The process of folding a block generally includes copying valid data stored by the block to another block in the memory device. For implementations that employ the page stripe scheme discussed above, after the valid data is folded from the block (also referred to herein as “fold data”), the data stored by the block is unreliable and as a result, corresponding parity data is ineffective and cannot be used to recover data. For example, if a block from Die 2 includes Die₂Pgₓ, and subsequently an uncorrectable error correction code (UECC) error is detected in a block in Die 0 that includes Die₀Pgₓ, there are two broken pages in the page stripe x, and as a result, the data stored by the page stripe x cannot be recovered using the parity data Dieₙ₋₁Pgₓ.

Aspects of the present disclosure address deficiencies of parity data handling in conventional block folding techniques with an improved approach that involves storing updated parity data intermixed with fold data. As an example, in performing data folding, a data folding and recovery component of a memory sub-system reads data from a page in a block that is being folded. The data may include user data and metadata. The page forms part of a page stripe, and parity data used to recover data stored by the page stripe is stored by a parity page in the page stripe. The data folding and recovery component reads initial parity data from the parity page (e.g., from the last page in the page stripe) and generates updated parity data based on the data read from the page and the initial parity data. Rather than saving the updated parity data back to the physical location at which the initial parity data is stored (e.g., from the last page in the page stripe), the data folding and recovery component writes the updated parity data to a location determined based on a write cursor. The write cursor controls a write order, for example, of fold data. The data folding and recovery component also stores the fold data read from the page to another location determined based on the write cursor. In this way, the data folding and recovery component stores parity data mixed with fold data, as noted above. For some embodiments, the folding and recovery component writes the fold data and updated parity data in parallel.

The folding and recovery component may utilize one or more caches to maintain a mapping between physical addresses and logical addresses associated with parity pages. For example, upon writing the updated parity data to the location determined by the write cursor, the folding and recovery component records the corresponding physical address and creates a cache entry that includes the physical address and the logical address associated with the parity page for the page stripe. To recover data stored by the page stripe, the folding and recovery component accesses the cache and uses the logical address associated with the parity page to identify the cache entry for the parity page associated with the page stripe. The folding and recovery component can identify the physical location corresponding to the parity page from the cache entry and retrieve the parity data for the page stripe therefrom.

This approach enables the memory sub-systems to extend the effectiveness of the parity protection schemes in performing data recovery in the memory device thereby providing an overall improvement to quality of service in memory sub-systems.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can be coupled to the memory sub-system 110 via a host interface. Examples of a host interface include, but are not limited to, a SATA interface, a PCIe interface, USB interface, Fibre Channel, Serial Attached SCSI (SAS), Small Computer System Interface (SCSI), a double data rate (DDR) memory bus, a DIMM interface (e.g., DIMM socket interface that supports Double Data Rate (DDR)), Open NAND Flash Interface (ONFI), Double Data Rate (DDR), Low Power Double Data Rate (LPDDR), or any other interface. The host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include NAND type flash memory and write-in-place memory, such as a three-dimensional cross-point (3D cross-point) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and 3D NAND.

Each of the memory devices 130 can include one or more arrays of memory cells. One type of memory cell, for example, single level cells (SLC), can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. For example, the memory device can include a set of blocks. Design specifications may define a constraint on a minimum number of valid blocks for the memory device 130 that may be different from the number of blocks in the set of blocks on the device.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), NOR flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system 120 into command instructions to access the memory devices 130 and/or the memory device 140 and convert responses associated with the memory devices 130 and/or the memory device 140 into information for the host system 120.

In some embodiments, the memory devices 130 include local media controllers 135 that operate in conjunction with memory sub-system controller 115 to execute operations on one or more memory cells of the memory devices 130.

The memory sub-system 110 also includes a data folding and recovery component 113 that is responsible for performing data folding and data recovery in the memory sub-system 110. In performing data folding, the data folding and recovery component 113 may read data from a page in a block that is being folded. The data may include user data and metadata. The page forms part of a page stripe and parity data used to recover data stored by the page stripe is stored by a parity page in the page stripe. The data folding and recovery component 113 reads initial parity data from the parity page and generates updated parity data based on the data read from the page and the initial parity data. Rather than saving the updated parity data back to the physical location at which the initial parity data is stored, the data folding and recovery component 113 writes the updated parity data to a location determined based on a write cursor. The write cursor controls a write order, for example, of fold data. The data folding and recovery component 113 also stores the data read from the page (also referred to as the “fold data”) to a location determined based on the write cursor. In this way, the data folding and recovery component 113 stores parity data mixed with fold data, and for some embodiments, the folding and recovery component 113 writes the fold data and updated parity data to new locations in parallel.

The folding and recovery component 113 may utilize one or more caches to maintain a mapping between physical addresses and logical addresses associated with parity pages. For example, upon writing the updated parity data to the location determined by the write cursor, the folding and recovery component 113 records the corresponding physical address and creates a cache entry that includes the physical address and the logical address associated with the parity page for the page stripe. To recover data stored by the page stripe, the folding and recovery component 113 accesses the cache and traverses the cache until the cache entry for the parity page associated with the page stripe is identified using the logical address associated with the parity page. The folding and recovery component 113 can identify the physical location corresponding to the parity page from the cache entry and retrieve the parity data for the page stripe therefrom. Further details regarding the functionality of the data folding and recovery component 113 are discussed below.

In some embodiments, the memory sub-system controller 115 includes at least a portion of the data folding and recovery component 113. For example, the memory sub-system controller 115 can include a processor 117 (processing device) configured to execute instructions stored in local memory 119 for performing the operations described herein. In some embodiments, the data folding and recovery component 113 is part of the host system 120, an application, or an operating system. In some embodiments, the local media controller 135 includes at least a portion of the data folding and recovery component 113.

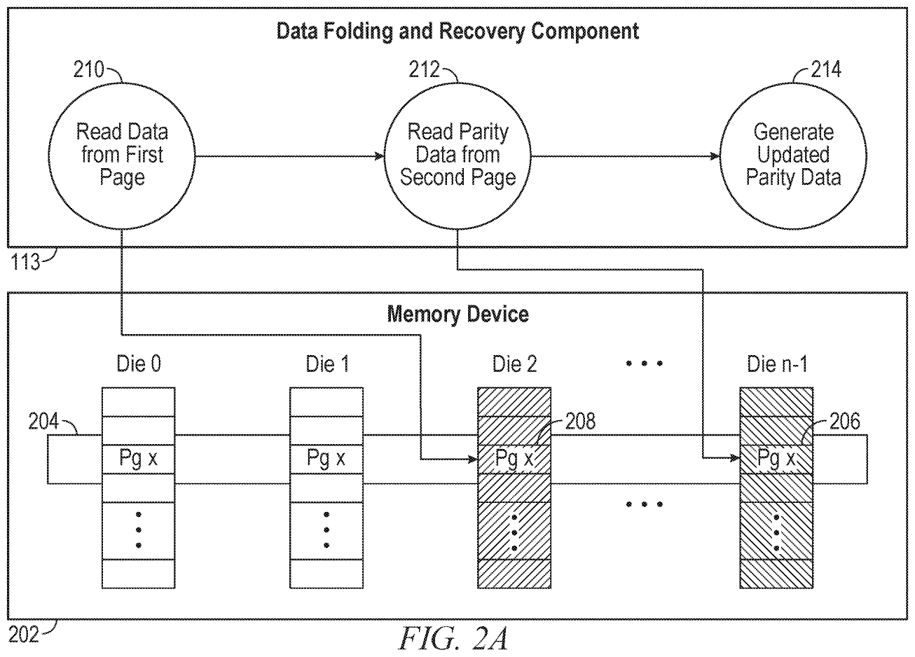

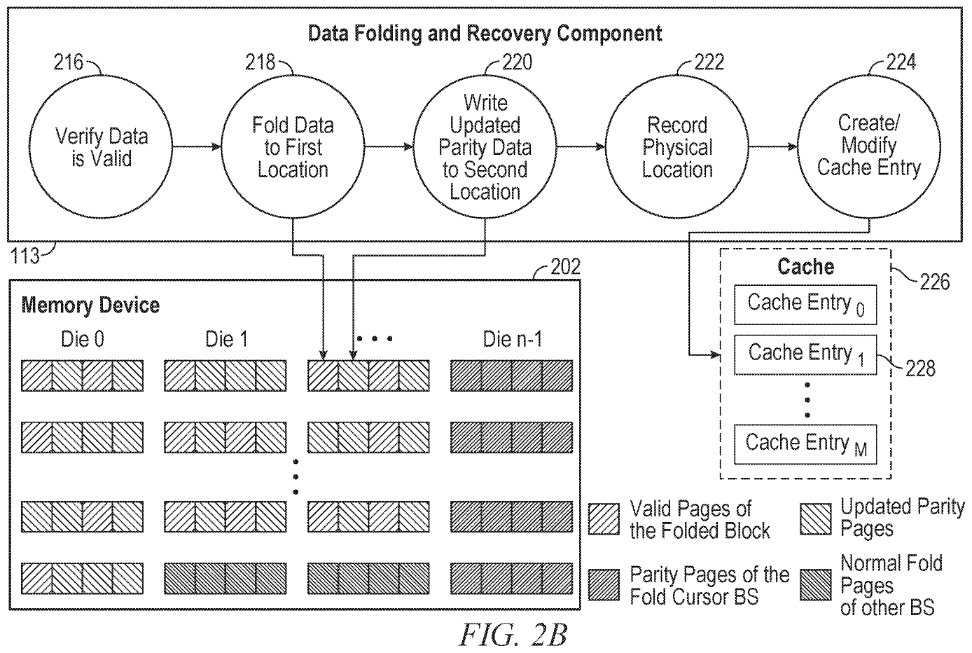

FIGS. 2A and 2B are conceptual diagrams illustrating example interactions between components of a memory sub-system in performing data folding, in accordance with some embodiments of the present disclosure. In the example illustrated in FIGS. 2A and 2B, the memory device 202 is an example memory device 130 in the example form of a NAND memory device. The memory device 202 includes multiple NAND dies. Specifically, in the example illustrated, the memory device includes n dies (dies 0 to n−1). Each die may include one or more planes and each plane includes multiple blocks. Each block includes 2D array that includes pages (rows) and strings (columns). A string includes a plurality of memory cells connected in series. Each memory cell is used to represent one or more bit values. A single NAND flash cell includes a transistor that stores an electric charge on a memory layer that is isolated by oxide insulating layers above and below.

Parallel blocks within the memory device 202 may be organized into block stripes. Pages within each die may be identified by page number, and pages with the same page number are grouped to form a page stripe. In the example illustrated in FIG. 2A, within a block stripe, a page stripe 204 includes a set of pages corresponding to page number x in each die of the memory device 202 (“Pg x” as illustrated).

The data folding and recovery component 113 generates parity data for each page stripe and the parity data for a given page stripe may be used to recover data stored by the page stripe (e.g., user data and metadata). The parity data may be generated, for example, by applying a logical XOR operator to data stored by each individual page in the page stripe. Parity data for each page stripe is stored in a page referred to as a “parity page.” Initially, a particular page in the page stripe is designated as the parity page such as the page of the page stripe that is in the last die. As an example, the data folding and recovery component 113 can generate initial parity data for the page stripe 204 as follows:

$${Die}_{n - 1} {Pg}_{x} = {Die}_{0} {Pg}_{x} ⊕ {Die}_{1} {Pg}_{x} ⊕ {Die}_{2} {Pg}_{x} ⊕ … ⊕ {Die}_{n - 3} {Pg}_{x} ⊕ {Die}_{n - 2} {Pg}_{x}$$

where Dieₙ₋₁Pgₓ refers to the parity data for the page stripe 204, Die₀Pgₓ refers to data stored by Page x of Die 0, Die₁Pgₓ refers to data stored by Page x of Die 1, and so forth. As illustrated, the initial parity data for the page stripe 204 is stored in page 206 of Die n−1, which also includes the initial parity pages for the other page stripes in the memory device 202.

The data folding and recovery component 113 may identify a block in the memory device 202 for folding, for example, based on detecting a failure of the block or detecting a bit error rate of the block exceeding a threshold bit error rate. For example, the data folding and recovery component 113 may identify a block for folding that includes page 208 of Die 2. Based on the block being identified for folding, the data folding and recovery component 113 reads the data stored by the page 208 (Die₂Pgₓ), at operation 210, and reads the initial parity data stored by the page 206 (Dieₙ₋₁Pgₓ), at operation 212, to generate updated parity data for the page stripe 204, at operation 214. The data folding and recovery component 113 may, for example, generate the updated parity data for the page stripe 204 as follows:

$${Die}_{n - 1} {Pg}_{x} ⊕ {Die}_{2} {Pg}_{x}$$

Referring to FIG. 2B, based on verifying that the data read from the page 208 (Die₂Pgₓ) is valid (operation 216), the data folding and recovery component 113 folds the data to a first location (e.g., corresponding to a first physical address) in the memory device 202 determined by a write cursor that controls the write order of fold data (operation 218). In folding the data to the first location, the data folding and recovery component 113 may write metadata to the first location that includes a logical address associated with the page 208.

Rather than storing the updated parity data to the page 206 of Die n−1, the data folding and recovery component 113 writes the updated parity data to a second location (e.g., corresponding to a second physical address) in the memory device 202 determined based on the write cursor (operation 220). That is, the data folding and recovery component 113 stores update parity data mixed with fold data, as illustrated by FIG. 2B.

A logical address (or other identifier) may be assigned to each parity page to be used to identify a physical address at which parity data is stored. For example, a parity page logical address may be calculated as follows:

$$( ( BS \# + 1 ) * PageCnt * ParityPageSize ) + ParityPageOffset$$

where BS#refers to a block stripe number (i.e., an identifier assigned to each block stripe), PageCnt refers to a page count per plane block, ParityPageSize refers to page size per parity data, and ParityPageOffset refers to a page offset. A more detailed breakdown of the logical addresses assigned to parity pages, in accordance with this example, is provided below in TABLE 1.

TABLE 1

| | | Parity Page Logical Address | |
|---|---|---|---|
| BS# | Page# | Start | End |
| 0 | 0 | 0 | ParityPageSize − 1 |
| | 1 | ParityPageSize | 2* ParityPageSize − 1 |
| | . . . | PageNo* ParityPageSize | (PageNo + 1)* ParityPageSize − 1 |
| | PageCnt − 1 | (PageCnt − 1)* ParityPageSize | PageCnt* ParityPageSize − 1 |
| 1 | 0 | PageCnt* ParityPageSize | (PageCnt + 1)* ParityPageSize − 1 |
| | 1 | (PageCnt + 1)* ParityPageSize | (PageCnt + 2)* ParityPageSize − 1 |
| | . . . | (PageCnt + PageNo)*ParityPageSize | (PageCnt + PageNo + 1)*ParityPageSize − 1 |
| | PageCnt − 1 | (2*PageCnt − 1)*ParityPageSize | (2*PageCnt)*ParityPageSize − 1 |

.
.
.

| | | | |
|---|---|---|---|
| BsCnt − 1 | 0 | ((BsCnt − | ((BsCnt − |
| | | 1)*PageCnt)*ParityPageSize | 1)*PageCnt + 1)*ParityPageSize − 1 |
| | 1 | ((BsCnt − | ((BsCnt − |
| | | 1)*PageCnt + 1)*ParityPageSize | 1)*PageCnt + 2)*ParityPageSize − 1 |
| | . . . | ((BsCnt − | ((BsCnt − 1)*PageCnt + PageNo + 1)* |
| | | 1)*PageCnt + PageNo)*ParityPageSize | ParityPageSize − 1 |
| | PageCnt − 1 | (BsCnt*PageCnt − 1)*ParityPageSize | (BsCnt*PageCnt)*ParityPageSize − 1 |

The logical address of a corresponding page may be included in metadata stored in each page along with the user data stored by the page. For example, the data read from page 208 (Die₂Pgₓ) may include metadata that specifies the logical address for the page 208.

The data folding and recovery component 113 maintains one or more caches (e.g., in the local memory 119) to track mappings between logical addresses associated with parity pages and physical addresses at which parity data is stored. For example, the data folding and recovery component 113 can maintain cache 226 that includes one or more cache entries. Each cache entry includes: a first field for a logical address associated with a parity page of a page stripe; a second field for a physical address at which parity data for the page stripe is stored; and a third field for a pointer to the next cache entry in the cache 226.

Upon writing the updated parity data to the location determined based on the write cursor, the data folding and recovery component 113 records the physical address corresponding to the location, at operation 222, and uses the physical address to create or modify a cache entry 228 in the cache 226, at operation 224. If a valid cache entry 228 for the page stripe 204 exists in the cache 226, the data folding and recovery component 113 updates the cache entry 228 by replacing a previous physical address specified by the cache entry 228 with the physical address corresponding to the updated parity data. If no such valid cache entry exists, the data folding and recovery component 113 creates a cache entry 228 in the cache 226 that includes the logical address of the parity page for the page stripe 204 and the physical address.

The data folding and recovery component 113 may employ an indexing scheme to aid in locating and traversing multiple caches. For some embodiments, the data folding and recovery component 113 may utilize a hash algorithm as part of the indexing scheme. For example, the data folding and recovery component 113 may determine a slot index corresponding to a cache as follows:

SlotIndex=(ParityPage logical address)/multiples of ParityPageSize % PageCnt

A more detailed breakdown of slot indexes determined in accordance with this example is provided below in TABLE 2.

TABLE 2

| BS ID | LTUs in ParityPageSize | Slot Index |
|---|---|---|
| 0 | 0, 1, . . . , ParityPageSize − 1 | 0 |
| | ParityPageSize, ParityPageSize + 1, . . . , 2*ParityPageSize − 1 | 1 |
| | . . . | . . . |
| | (PageCnt − 1)* ParityPageSize, (PageCnt − 1)* | PageCnt − 1 |
| | ParityPageSize + 1, . . . , PageCnt* ParityPageSize − 1 | |
| 1 | PageCnt* ParityPageSize, PageCnt* ParityPageSize + 1, . . . , | 0 |
| | (PageCnt + 1)* ParityPageSize − 1 | |
| | (PageCnt + 1)* ParityPageSize, (PageCnt + 1)* | 1 |
| | ParityPageSize + 1, . . . , (PageCnt + 2)* ParityPageSize − 1 | |
| | . . . | . . . |
| | (2*PageCnt − 1)* ParityPageSize, (2*PageCnt − 1)* | PageCnt − 1 |
| | ParityPageSize + 1, . . . , (2*PageCnt)* ParityPageSize − 1 | |
| . . . | . . . | . . . |

To be able to use parity data to recover data for the page stripe 204, the data folding and recovery component 113 identifies a location of the cache 226 based on the index scheme discussed above, accesses the cache 226 at the location, traverses the cache 226 until identifying the cache entry 228 based on the logical address, identifies the physical address at which the parity data is stored from the cache entry 228, and retrieves the parity data from the location corresponding to the physical address. Initially, before the updated parity data is generated, no valid cache entry for the parity page for the page stripe 204 exists in the cache 226, in which case the data folding and recovery component 113 retrieves the initial parity data stored by the page 206.

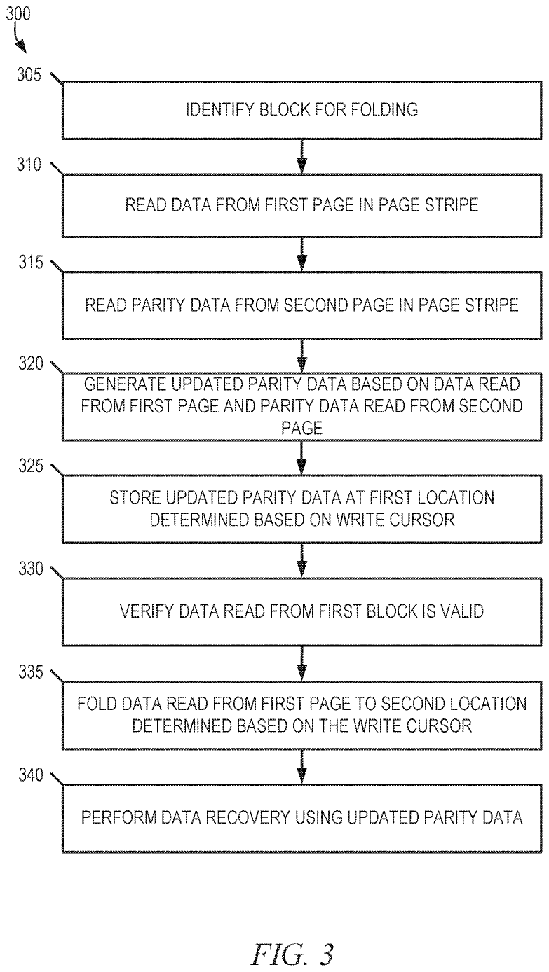

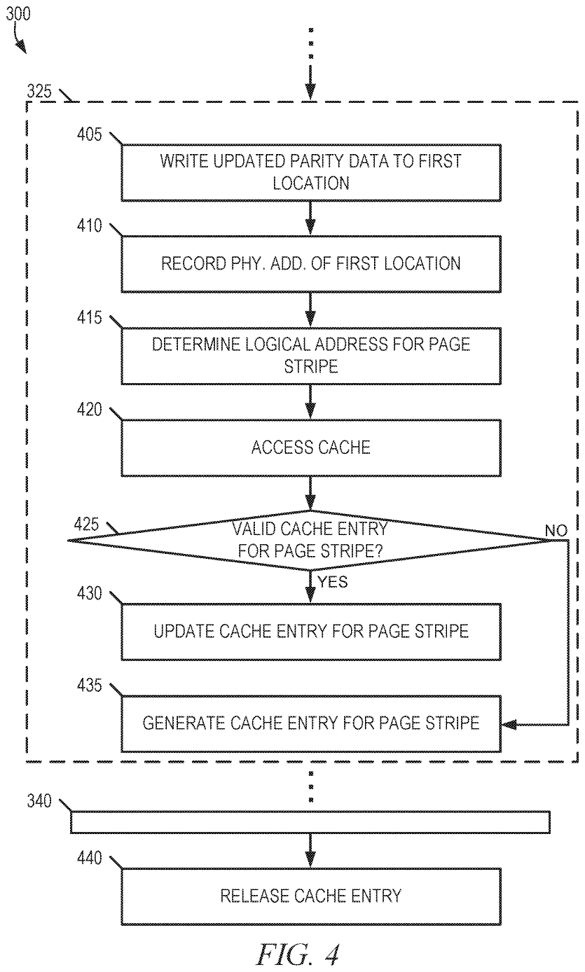

FIGS. 3 and 4 are flow diagrams illustrating an example method 300 for performing data folding in a memory device (e.g., memory device 130), in accordance with some embodiments of the present disclosure. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 300 is performed by the data folding and recovery component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method 300 begins at operation 305, where the processing device identifies a block in the memory device to be folded. For some embodiments, the processing device identifies the block as part of a garbage collection process. In some instances, the processing device identifies the block based on detecting a bit error rate of the block exceeds a threshold bit error rate. In some instances, the processing device identifies the block based on detecting a failure of the block. In some instances, the processing device may determine the block is a bad block based on the bit error rate or failure of the block, and may identify the block for folding based on the block being a bad block.

Based on the block being identified for folding, the processing device performs operations 310, 315, 320, 325, 330, 335, and 340 for each page in the block. Accordingly, though the description of 310, 315, 320, 325, 330, 335, and 340 that follows address folding a single page of the block, it shall be appreciated that these operations are repeated for each page in the block.

At operation 310, the processing device reads data from a first page in the block. The data read from the first page is also referred to herein as “fold data.” The first page forms part of a page stripe. The page stripe comprises multiple pages that are distributed among multiple dies of the memory device and share the same page number. That is, each page in the page stripe belongs to a different die in the memory device but shares the same page number. The data read from the first page may include user data and metadata. The metadata may include a logical address associated with the page.

A second page in the page stripe is designated for storing parity data that can be used to recover data stored by the page stripe. For some embodiments, the second page that is designated to store the initial parity data corresponds to the last page in the page stripe. The processing device, at operation 315, reads the parity data from the second page in the page stripe.

The processing device generates updated parity data based on the data read from the first page and the parity data read from the second page, at operation 320. For example, the processing device may generate the updated parity data as follows:

$${Die}_{n - 1} {Pg}_{x} ⊕ {Die}_{y} {Pg}_{x}$$

Where Dieₙ₋₁Pgₓ corresponds to the parity data read from the second page (with Dieₙ₋₁ referring the last die of the memory device in which the second page resides) and Die_{y}Pgₓ referring to the data read from the first page (with Die_{y} referring to the die of the memory device in which the first page resides).

At operation 325, the processing device stores the updated parity data. As will be discussed in further detail below in reference to FIG. 4, in storing the updated parity data, the processing device writes the parity data to a first location in the memory device (e.g., a third page) determined based on a write cursor that controls the write order for data written to a page stripe. For example, the write cursor may provide a first physical address (e.g., corresponding to the third page) in the memory device at which the updated parity data is to be written.

The processing device, at operation 330, verifies that the fold data is valid, and based on verifying the fold data is valid, the processing device folds the data to a second location in the memory device (e.g., a fourth page) determined based on the write cursor, at operation 335. For example, the write cursor may provide a second physical address (e.g., corresponding to the fourth page) and the processing device may write the fold data to the second physical address. In writing the fold data to the second physical address, the processing device may write metadata that includes a logical address associated with the first page.

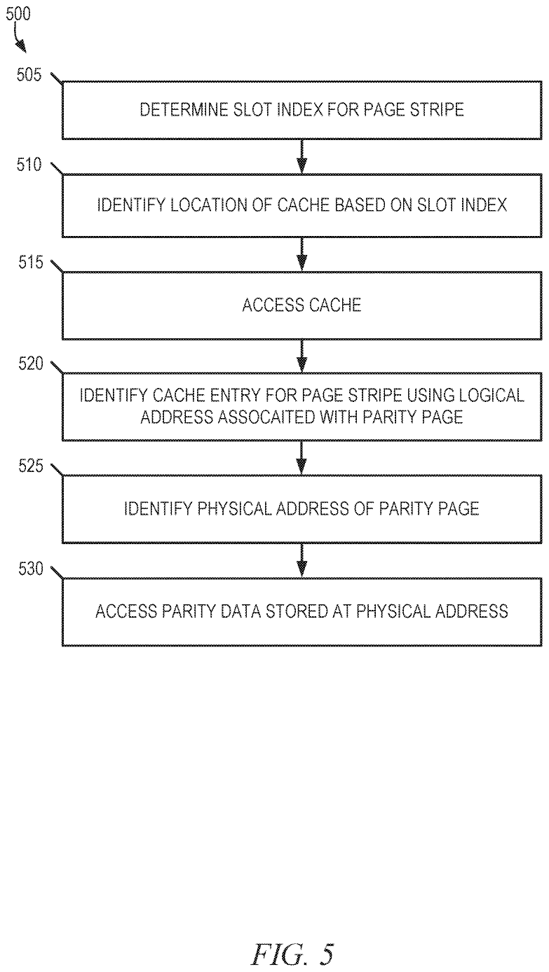

At operation 340, the processing device performs data recovery on the page stripe using the updated parity data. In recovering the data, the processing device reads the updated parity data from the parity page, reads data stored by pages of the page stripe, and applies a logical XOR operator to the two sets of data. Further details regarding data recovery are discussed below in reference to FIG. 5.

As shown in FIG. 4, the method 300 may, in some embodiments, further include operations 405, 410, 415, 420, 425, 430, 435, and 440. Consistent with these embodiments, the 405, 410, 415, 420, 425, 430, and 435 can be performed as part of the operation 325, where the processing device stores the updated parity data.

At operation 405, the computing device writes the updated parity data to the first location (e.g., the third page) in the memory device determined based on the write cursor, as mentioned above. At operation 410, the processing device records a physical address corresponding to the first location at which the parity data is written.

As noted above, each page stripe in the memory device may have a parity page with an assigned logical address that can be used to identify a physical address of the parity page, which will be discussed in further detail below. At operation 415, the processing device determines a logical address associated with a parity page corresponding to the page stripe. The processing device may, for example, determine the logical address based on metadata included in the data read from the first page or based on the formula discussed above in reference to FIGS. 2A and 2B.

The processing device, at operation 420, accesses a cache (e.g., from local memory 119) comprising information to identify one or more physical locations in the memory device corresponding to one or more parity pages. That is, the cache includes a set of cache entries and each cache entry comprises a logical address and a physical address associated with a parity page. At operation 425, the processing device determines whether the cache includes a valid cache entry for the parity page of the page stripe. If the processing device identifies a valid cache entry, the processing device updates the valid cache entry to include the physical address corresponding to the location at which the updated parity data for the page stripe is written, at operation 430. In updating the valid cache entry, the processing device may replace a prior physical address included in the cache entry with the current physical address corresponding to the location at which the updated parity data is written.

If the processing device determines that no valid cache entry for the parity page for the page stripe exists in the cache, the processing device generates a cache entry in the cache for the parity page, at operation 435. As noted above, the cache entry comprises the physical address at which the updated parity data for the page stripe is written and the logical address associated with the parity page for the page stripe. Each cache entry in the cache may further include a pointer to the next cache entry in the cache to facilitate traversal of the cache.

Consistent with these embodiments, the operation 440 can be performed subsequent to an iteration of operation 335 in which the last page in the block is folded. That is, the operation 440 can be performed subsequent to folding all pages in the block. At operation 440, the processing device releases the cache entry upon folding the entire block.

FIG. 5 is a flow diagram illustrating an example method 500 for retrieving parity data to be used in performing data recovery in a memory device, in accordance with some embodiments of the present disclosure. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 500 is performed by the data folding and recovery component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. For some embodiments, the method 500 can be performed as part of operation 340 of the method 300 where the computing device performs data recovery for the page stripe.

At operation 505, the processing device determines a slot index corresponding to the cache based on the logical address associated with the parity page, a size of the parity page, and a page count per block. The slot index is used to identify a location at which the cache is stored (e.g., in local memory 119). The processing device may determine the slot index in accordance with the methodology discussed above.

The processing device identifies a location of the cache based on the slot index, at operation 510, and accesses the cache, at operation 515. As noted above, the cache comprises a set of cache entries used to identify physical addresses of parity pages. Each cache entry includes: a first field for a logical address associated with a parity page; a second field for a physical address corresponding to the parity page; and a third field that includes a pointer to the next cache entry in the cache.

At operation 520, the processing device identifies the cache entry corresponding to the parity page of the page stripe using the logical address associated with the parity page. The processing device may traverse one or more cache entries utilizing the pointer in the third field of each entry before identifying the cache entry corresponding to the parity page.

From the cache entry, the processing device identifies the physical address of the parity page at which the updated parity data is written, at operation 525. The processing device accesses the updated parity data from the parity page at the physical location for using in recovery data stored by the page stripe, at operation 530.

Described implementations of the subject matter can include one or more features, alone or in combination as illustrated below by way of example.

Example 1 is a memory sub-system comprising: a memory device; and a processing device, operatively coupled with the memory device, configured to perform operations comprising: reading data from a first page of the memory device that is identified for folding, the first page corresponding to a page stripe, the page stripe comprising at least a second page; reading, from the second page, parity data associated with the page stripe; generating updated parity data for the page stripe based on the data read from the first page and the parity data read from the second page; storing the updated parity data, the storing of the updated parity data comprising writing the updated parity data to a first location in the memory device determined based on a write cursor; and folding the data read from the first page to a second location in the memory device determined based on the write cursor.

Example 2 includes the subject matter of Example 1, wherein the storing of the updated parity data further comprises: determining a logical address associated with a parity page corresponding to the page stripe; and recording a physical address of the first location upon writing the data to the first location.

Example 3 includes the subject matter of any one or more of Examples 1 or 2, wherein the storing of the updated parity data further comprises: accessing a cache comprising information to identify one or more physical locations in the memory device corresponding to one or more parity pages; and determining whether a valid cache entry for the parity page exists in the cache.

Example 4 includes the subject matter of any one or more of Examples 1-3, wherein the storing of the updated parity data further comprises: the physical address is a first physical address; and the storing of the updated parity data further comprises: identifying a valid cache entry for the parity page in the cache, the valid cache entry comprising a second physical address; and updating the valid cache entry to include the physical address, the updating comprising replacing the second physical address with the first physical address.

Example 5 includes the subject matter of any one or more of Examples 1-4, wherein the storing of the updated parity data further comprises: based on determining no valid cache entry for the parity page exists in the cache, generating a cache entry for the parity page comprising the logical address and the physical address.

Example 6 includes the subject matter of any one or more of Examples 1-5, wherein the operations further comprise releasing the cache entry.

Example 7 includes the subject matter of any one or more of Examples 1-6, wherein the operations further comprise performing data recovery on the page stripe using the updated parity data, the performing of data recovery comprising: accessing a cache comprising information to identify one or more physical locations in the memory device corresponding to one or more parity pages; identifying a cache entry in the cache using a logical address of the parity page for the page stripe; identifying a physical address of the parity page based on the cache entry; and accessing the updated parity data from the parity page using the physical address.

Example 8 includes the subject matter of any one or more of Examples 1-7, wherein the performing of data recovery further comprises: determining a slot index based on the logical address of the parity page, a size of the parity page, and a page count per block; and identifying a location of the cache based on the slot index.

Example 9 includes the subject matter of any one or more of Examples 1-8, wherein: the operations further comprise verifying the data is valid; and the folding of the data from the first page to the second location is based on verifying the data is valid.

Example 10 includes the subject matter of any one or more of Examples 1-9, wherein the operations further comprise identifying of a block for folding, the block comprising the first page, the identifying of the block for folding comprising one of: determining a bit error count of the block exceeds a threshold bit error count; and detecting a failure of the block.

Example 11 is a method comprising: reading data from a first page of a memory device based on the first page being identified for folding, the first page corresponding to a page stripe, the page stripe comprising at least a second page; reading, from the second page, parity data associated with the page stripe; generating updated parity data for the page stripe based on the data read from the first page and the parity data read from the second page; writing the updated parity data to a first location in the memory device determined based on a write cursor; and writing the data read from the first page to a second location in the memory device determined based on the write cursor.

Example 12 includes the subject matter of Example 11, wherein the storing of the updated parity data further comprises: determining a logical address associated with a parity page corresponding to the page stripe; and recording a physical address of the first location upon writing the data to the first location.

Example 13 includes the subject matter of any one or more of Examples 11 or 12, wherein the storing of the updated parity data further comprises: accessing a cache comprising information to identify one or more physical locations in the memory device corresponding to one or more parity pages; and determining whether a valid cache entry for the parity page exists in the cache.

Example 14 includes the subject matter of any one or more of Examples 11-13, wherein the storing of the updated parity data further comprises: the physical address is a first physical address; and the storing of the updated parity data further comprises: identifying a valid cache entry for the parity page in the cache, the valid cache entry comprising a second physical address; and updating the valid cache entry to include the physical address, the updating comprising replacing the second physical address with the first physical address.

Example 15 includes the subject matter of any one or more of Examples 11-14, wherein the storing of the updated parity data further comprises: based on determining no valid cache entry for the parity page exists in the cache, generating a cache entry for the parity page comprising the logical address and the physical address.

Example 16 includes the subject matter of any one or more of Examples 11-15, wherein the operations further comprise releasing the cache entry.

Example 17 includes the subject matter of any one or more of Examples 11-16, wherein the operations further comprise performing data recovery on the page stripe using the updated parity data, the performing of data recovery comprising: accessing a cache comprising information to identify one or more physical locations in the memory device corresponding to one or more parity pages; identifying a cache entry in the cache using a logical address of the parity page for the page stripe; identifying a physical address of the parity page based on the cache entry; and accessing the updated parity data from the parity page using the physical address.

Example 18 includes the subject matter of any one or more of Examples 11-17, wherein the performing of data recovery further comprises: determining a slot index based on the logical address of the parity page, a size of the parity page, and a page count per block; and identifying a location of the cache based on the slot index.

Example 19 includes the subject matter of any one or more of Examples 11-18, wherein: the operations further comprise verifying the data is valid; and the folding of the data from the first page to the second location is based on verifying the data is valid.

Example 20 is a non-transitory computer-readable storage medium comprising instructions that, when executed by a processing device, configure the processing device to perform operations comprising: reading data from a first page of a memory device, the first page corresponding to a page stripe, the page stripe comprising at least a second page; reading, from the second page, parity data associated with the page stripe; generating updated parity data for the page stripe based on the data read from the first page and the parity data read from the second page; writing the updated parity data to a first location in the memory device determined based on a write cursor; and folding the data read from the first page to a second location in the memory device determined based on the write cursor.

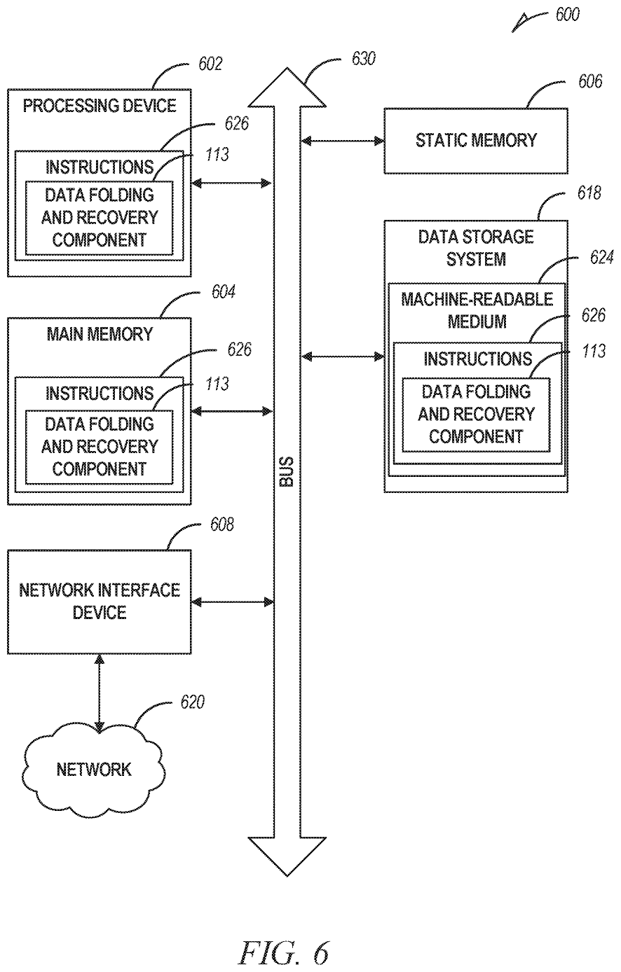

FIG. 6 illustrates an example machine in the form of a computer system 600 within which a set of instructions can be executed for causing the machine to perform any one or more of the methodologies discussed herein. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the data folding and recovery component 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an ASIC, a FPGA, a digital signal processor (DSP), network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a data destruction component (e.g., the data folding and recovery component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

1. A memory sub-system comprising:
a memory device; and
a processing device, operatively coupled with the memory device, configured to perform operations comprising:
reading data from a first page of the memory device that is identified for folding, the first page corresponding to a page stripe, the page stripe comprising at least a second page;
reading, from the second page, parity data associated with the page stripe;
generating updated parity data for the page stripe based on the data read from the first page and the parity data read from the second page;
storing the updated parity data, the storing of the updated parity data comprising writing the updated parity data to a first location in the memory device determined based on a write cursor; and
folding the data read from the first page to a second location in the memory device determined based on the write cursor.

2. The memory sub-system of claim 1, wherein the storing of the updated parity data further comprises:
determining a logical address associated with a parity page corresponding to the page stripe; and
recording a physical address of the first location upon writing the data to the first location.

3. The memory sub-system of claim 2, wherein the storing of the updated parity data further comprises:
accessing a cache comprising information to identify one or more physical locations in the memory device corresponding to one or more parity pages; and
determining whether a valid cache entry for the parity page exists in the cache.

4. The memory sub-system of claim 3, wherein the storing of the updated parity data further comprises:
the physical address is a first physical address; and
the storing of the updated parity data further comprises:
identifying a valid cache entry for the parity page in the cache, the valid cache entry comprising a second physical address; and
updating the valid cache entry to include the physical address, the updating comprising replacing the second physical address with the first physical address.

5. The memory sub-system of claim 3, wherein the storing of the updated parity data further comprises:
based on determining no valid cache entry for the parity page exists in the cache, generating a cache entry for the parity page comprising the logical address and the physical address.

6. The memory sub-system of claim 5, wherein the operations further comprise releasing the cache entry.

7. The memory sub-system of claim 1, wherein the operations further comprise performing data recovery on the page stripe using the updated parity data, the performing of data recovery comprising:
accessing a cache comprising information to identify one or more physical locations in the memory device corresponding to one or more parity pages;
identifying a cache entry in the cache using a logical address of the parity page for the page stripe;
identifying a physical address of the parity page based on the cache entry; and
accessing the updated parity data from the parity page using the physical address.

8. The memory sub-system of claim 7, wherein the performing of data recovery further comprises:
determining a slot index based on the logical address of the parity page, a size of the parity page, and a page count per block; and
identifying a location of the cache based on the slot index.

9. The memory sub-system of claim 1, wherein:
the operations further comprise verifying the data is valid; and
the folding of the data from the first page to the second location is based on verifying the data is valid.

10. The memory sub-system of claim 9, wherein the operations further comprise identifying of a block for folding, the block comprising the first page, the identifying of the block for folding comprising one of:
determining a bit error count of the block exceeds a threshold bit error count; and
detecting a failure of the block.

11. A method comprising:
reading data from a first page of a memory device based on the first page being identified for folding, the first page corresponding to a page stripe, the page stripe comprising at least a second page;
reading, from the second page, parity data associated with the page stripe;
generating updated parity data for the page stripe based on the data read from the first page and the parity data read from the second page;
writing the updated parity data to a first location in the memory device determined based on a write cursor; and
writing the data read from the first page to a second location in the memory device determined based on the write cursor.

12. The method of claim 11, further comprising:
determining a logical address associated with a parity page corresponding to the page stripe; and
recording a physical address of the first location upon writing the data to the first location.

13. The method of claim 12, further comprising:
accessing a cache comprising information to identify one or more physical locations in the memory device corresponding to one or more parity pages; and
determining whether a valid cache entry for the parity page exists in the cache.

14. The method of claim 13, wherein:
the physical address is a first physical address; and
the method further comprises:
identifying a valid cache entry for the parity page in the cache, the valid cache entry comprising a second physical address; and
updating the valid cache entry to include the physical address, the updating comprising replacing the second physical address with the first physical address.

15. The method of claim 13, further comprising:
based on determining no valid cache entry for the parity page exists in the cache, generating a cache entry for the parity page comprising the logical address and the physical address.

16. The method of claim 15, further comprising releasing the cache entry.

17. The method of claim 11, further comprising performing data recovery on the page stripe using the updated parity data, the performing of data recovery comprising:
accessing a cache comprising information to identify one or more physical locations in the memory device corresponding to one or more parity pages;
identifying a cache entry in the cache using a logical address of the parity page for the page stripe;
identifying a physical address of the parity page based on the cache entry; and
accessing the updated parity data from the parity page using the physical address.

18. The method of claim 17, wherein the performing of data recovery further comprises:
determining a slot index based on the logical address of the parity page, a size of the parity page, and a page count per block; and
identifying a location of the cache based on the slot index.

19. The method of claim 11, further comprising verifying the data is valid, wherein the writing of the data from the first page to the second location is based on verifying the data is valid.

20. A non-transitory computer-readable storage medium comprising instructions that, when executed by a processing device, configure the processing device to perform operations comprising:
reading data from a first page of a memory device, the first page corresponding to a page stripe, the page stripe comprising at least a second page;
reading, from the second page, parity data associated with the page stripe;
generating updated parity data for the page stripe based on the data read from the first page and the parity data read from the second page;
writing the updated parity data to a first location in the memory device determined based on a write cursor; and
folding the data read from the first page to a second location in the memory device determined based on the write cursor.
